(19) United States
(12) Patent Application Publication
(10) Pub. No.: US 2026/0098141 A1
(43) Pub. Date: Apr. 9, 2026

(54) COMPOSTABLE POLYMER AEROGELS, PROCESSES AND INTERMEDIATE MIXTURES FOR THEIR FABRICATION, AND COMPONENTS FORMED THEREWITH

(71) Applicants: The Trustees of Indiana University, Bloomington, IN (US); Universities Space Research Association, Cleveland, OH (US)

(72) Inventors: Andres Tovar, Carmel, IN (US); Amanda P. Siegel, Bloomington, IN (US); Jacob Staker, Mooresville, IN (US); Haiquan Guo, Bloomington, IN (US)

(21) Appl. No.: 19/353,896

(22) Filed: Oct. 9, 2025

Related U.S. Application Data
(60) Provisional application No. 63/705,299, filed on Oct. 9, 2024.

(51) Int. Cl. C08J 9/28

(52) U.S. Cl. CPC C08J 9/28; C08J 2201/0522; C08J 2205/026; C08J 2303/12

(57) ABSTRACT

Compostable polymer aerogels, processes and intermediate mixtures for their fabrication, and components formed therewith. The compostable polymer aerogels are made from biodegradable starch polymers and biodegradable plasticizers mixed with a biodegradable chemical initiator and polymerized with a biodegradable solvent to form a raw gel containing cross-linked polymer chains. The raw gel is aged in a sealed environment that prevents escape of the aqueous solvent from the raw gel and forms a hydrogel having a nanoporous skeletal structure. The hydrogel is saturated with an organic solvent, and the organic solvent is then removed from the hydrogel without collapsing the nanoporous skeletal structure to form the compostable polymer aerogel. The compostable polymer aerogels may be particularly useful for forming various aerospace components, such as various insulation and structural components, as well as myriad other products that might benefit from light weight and/or a nanoporous skeletal structure.

### CROSS-REFERENCE TO RELATED APPLICATIONS

This application claims the benefit of provisional U.S. Patent Application No. 63/705,299 filed Oct. 9, 2024, the contents of which are incorporated herein by reference.

### BACKGROUND OF THE INVENTION

The invention generally relates to polymer aerogels and their uses in structural components. More particularly, the invention relates to compostable polymer aerogels, processes and intermediate mixtures for their fabrication, and components formed therewith.

Conventional single-use components, such as those used in aerospace, packaging, and insulation, are often fabricated from lightweight foam formed from aerogels made from non-biodegradable materials, including nylon, polystyrene, and/or other petroleum-based materials. These materials contribute to long-term environmental pollution and introduce persistent microplastics into terrestrial and aquatic ecosystems. In high-powered rocketry and other applications, for example, some structural and/or other sacrificial components made from conventional petroleum-based materials are intentionally broken and discarded after use, further exacerbating plastic waste. Similar environmental challenges arise in other industries, such as cryogenic storage, biomedical devices, marine buoyancy modules, acoustic and thermal insulation for consumer electronics, and protective packaging for transportation and sports equipment, where conventional petroleum-based polymer foams are widely used but rarely recovered or recycled. Therefore, there is a need for biodegradable, high-performance foam alternatives that can match the mechanical and thermal properties of conventional petroleum-based materials while offering a sustainable, environmentally friendly end-of-life profile.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, compostable polymer aerogels, processes and intermediate mixtures for fabricating compostable polymer aerogels, and aerospace components, insulation materials, and other structural components formed of compostable polymer aerogels.

According to a nonlimiting aspect, an intermediate mixture for fabricating a compostable polymer aerogel includes at least one biodegradable starch polymer, a biodegradable plasticizer, a biodegradable chemical initiator, and an aqueous solvent.

According to another nonlimiting aspect, a process of fabricating a compostable polymer aerogel includes dissolving at least one biodegradable starch polymer, a biodegradable plasticizer, and a biodegradable chemical initiator in an aqueous solvent to form an intermediate mixture. A gelation reaction is caused in the intermediate mixture by heating the intermediate mixture to a gelation temperature for a period of time sufficient to form a raw gel. The raw gel is aged in a sealed environment that prevents escape of the aqueous solvent from a gel structure of the raw gel to form a hydrogel having a nanoporous structure. The hydrogel is saturated with an organic solvent. The organic solvent and any aqueous solvent are removed from the hydrogel without collapsing the nanoporous structure to form the compostable polymer aerogel.

According to yet another nonlimiting aspect, a compostable polymer aerogel is provided that is fabricated according to a process as described above.

According to still another nonlimiting aspect, a compostable polymer aerogel includes a gel having a nanoporous skeletal structure formed of biodegradable starch polymer, biodegradable plasticizer, and a biodegradable chemical initiator. The compostable polymer aerogel has a density of about 0.1 to about 0.2 g/cm³ and a thermal conductivity of about 0.05 W/m-K or less.

In still further nonlimiting aspects, one or more of an aerospace component, an insulation material, and a structural component may be formed of the compostable polymer aerogels described above.

Technical aspects of methods and compostable polymer aerogels as described above preferably include the ability to provide an environmentally friendly alternative to conventional thermoplastics used to make aerospace components, insulation materials, and other items often made from thermoplastics. For example, in some embodiments, the products and methods disclosed herein can enable the production of high-porosity aerogels using biodegradable materials, such as potato starch, resulting in environmentally friendly alternatives to conventional petroleum-based foams and insulation materials.

These and other aspects, arrangements, features, and/or technical effects will become apparent upon detailed inspection of the figures and the following description.

### BRIEF DESCRIPTION OF THE DRAWINGS

FIG. 1 represents a chemical formulation of a chemical structure that can be used for making the compostable polymer aerogel according to a nonlimiting embodiment of the invention.

FIG. 2 schematically shows steps in a process of fabricating a compostable polymer aerogel according to a nonlimiting embodiment of the invention.

FIG. 3 is a graph representing shrinkage data of set gels observed in five different solvent exchange bath processes listed in Table 1.

FIG. 4 shows five different test samples of compostable polymer aerogels made with five different solvent exchange processes listed in Table 1.

FIG. 5 is a chart comparing bulk densities, skeletal densities, and porosities of compostable polymer aerogel samples Mk 6.2 to 6.5 listed in Table 1.

FIG. 6 schematically shows steps in another process of fabricating a compostable polymer aerogel according to a nonlimiting embodiment of the invention.

FIG. 7 schematically shows a nonlimiting example of the process of FIG. 6.

FIG. 8 shows potato starch aerogels and chitin/potato starch blend aerogels according to some nonlimiting aspects of the invention.

FIG. 9 shows two scanning electron microscopy images comparing the microstructures of two compostable polymer aerogels made of potato starch aerogels (PSAs) fabricated using two different solvent exchange protocols. Both images are shown at the same magnification with a 100 μm scale bar.

FIG. 10 is a schematic representation of a rocket with certain components formed from a compostable polymer aerogel.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The present invention relates generally to processes of producing a polymer aerogel derived from one or more starches, also called a thermoplastic starch aerogel (TPSA). The polymer aerogel is biodegradable and compostable, while also exhibiting mechanical strength and thermal insulation properties that result in the compostable polymer aerogel being a candidate for high-powered rocketry applications, as well as many other aerospace, industrial, commercial, and consumer applications. For example, other potential applications include, but are not limited to, consumer packaging replacing polystyrene foam, other lightweight, synthetic shock absorbers, and thermal insulators. As opposed to a “biodegradable material” that may take many years to eventually decompose into its constituent components, the term “compostable material” is used herein to refer to a biodegradable material that takes much less time, typically on the order of one year or less, to decompose into natural, soil-like material. For example, a compostable material is typically understood as a material capable of undergoing aerobic biological decomposition in a compost system, such that the material breaks down into natural elements, such as carbon dioxide, water, biomass and/or nutrient-rich soil conditioners, such as compost, mulch, and humus, within less than one year, and preferably within less than about three to six months, and/or as defined by American standard ASTM D6400-21, and/or as defined by European standard EN13432.

The compostable (and thus also biodegradable) polymer aerogel is preferably formed in a solution-to-gel (“sol-gel”) process from an intermediate mixture 18 containing four primary biodegradable ingredients: one or more biodegradable starch polymers, a biodegradable plasticizer, a biodegradable chemical initiator (e.g., a biodegradable catalyst), and a biodegradable aqueous solvent. Amylose and amylopectin are two molecules of starch found in food starches such as (but not limited to) potato starches, corn starches, and rice starches, that may be used as the biodegradable starch polymers. Potato starch was utilized in investigations leading to the present invention, though suitable biodegradable starches may be extracted from other plants as well. A nonlimiting example of a biodegradable plasticizer that can be used in the formulation for the compostable polymer aerogel is vegetable-derived glycerol (e.g., in a commercially available glycerin), which can be extracted from vegetable fats, such as palm, soy, and coconut oils, for example. Advantages of using a vegetable-derived glycerol are that they are viscous, odorless, have a very high boiling point, and are excellent plasticizers for amylose and amylopectin. Acetic acid was used as the biodegradable chemical initiator (catalyst) in the investigations leading to the present invention. Acetic acid functions as a clever for amylopectin and as a catalyst for glycerol in aqueous solutions. Acetic acid can be obtained, for example, from white vinegar. The aqueous solvent used in the intermediate mixture may be water. Deionized or distilled water may be used to provide better process control.

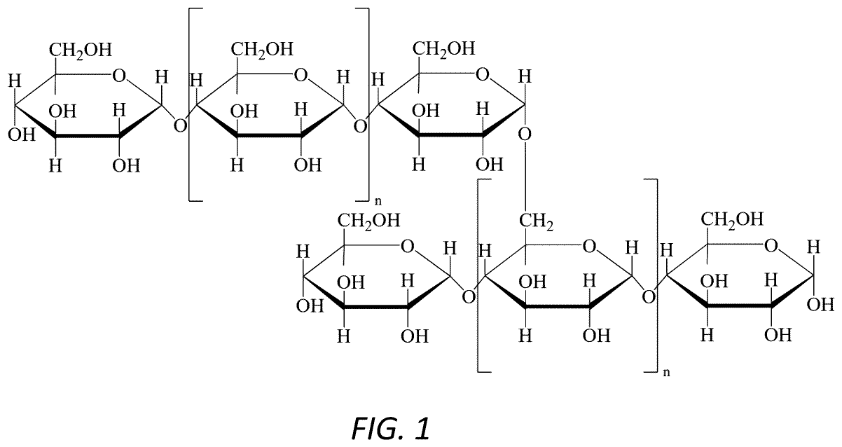

When washed with an organic solvent (for example, ethanol) and then dried via deep freezing protocol (DFP) and/or supercritical drying (SCD), amylose and amylopectin are able to provide a desirable polymer macrostructure, in particular a nanoporous skeletal structure, within a compostable polymer aerogel produced therefrom. FIG. 1 illustrates the chemical structure of amylopectin having α-1,4 linkages (left circled bond) and α-1,6 linkages (right circled bond). The potato starch used in the investigations had an amylose to amylopectin ratio of about 30:70 by weight.

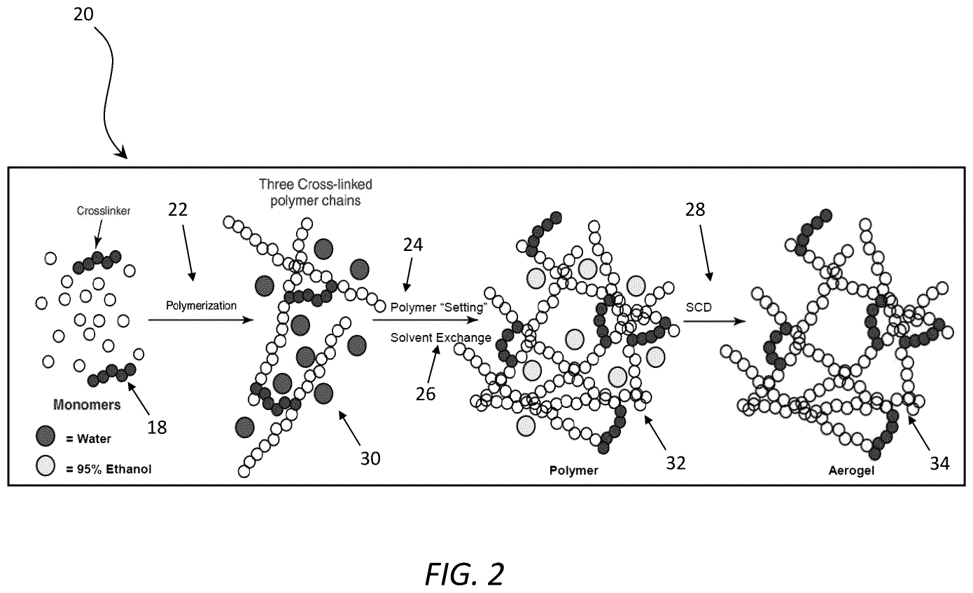

Turning to FIG. 2, the compostable polymer aerogel 34 may be formed by a multi-step process 20. In one embodiment, the process 20 includes a polymerization step 22, a polymer setting step 24, a solvent exchange step 26, and a solvent removal (“drying”) step 28, ultimately resulting in the production of the compostable polymer aerogels 34.

In the polymerization step 22, a gelation process occurs that involves a gelation chemical reaction (polymerization) of a homogeneous mixture of the intermediate mixture 18 described above. For this step 22, the intermediate mixture 18 may undergo agitation to form the homogenous mixture. In the polymerization step 22, the potato starch, plasticizer (crosslinker), and catalyst are mixed and dispersed in a solvent (water) and heated to drive the gelation process, which forms cross-linked polymer chains to form a type of intermediate, raw gel 30 (also referred to as a “sol” or “sol-gel”). The gelation process typically occurs at temperatures of about 50° C. to about 95° C., for example, about 60° C. to about 70° C., over a period of time ranging from about 20 seconds to about 20 minutes to form a sol gel structure, although longer gelation periods may be needed for larger scaled synthesis at industrial levels.

After the gelation process, the raw gel 30 is preferably allowed to age for a period of time during the polymer setting step 24 to allow a nanoporous structure of the gel 30 to form and harden (“set”), thereby creating a hydrogel 42 having the aqueous solvent dispersed within the nanoporous structure. The aging process may occur over an aging period of a few hours (e.g., 4-12 hours) up to a day (e.g., 12-24 hours) or longer. During the aging process, the raw gel 30 is sealed in an airtight container to ensure that no solvent escapes from the raw gel 30, and the gel structure undergoes further chemical evolution, leading to improved mechanical properties and uniformity, including the formation of the nanoporous structure of the raw gel 30, referred to herein as the hydrogel 42 when the aging period is over. The nanoporous structure has a tightly packed network of cross-linked polymer chains forming a strong rigid structural framework with a large number of nano-scale pores formed between polymer chains, thereby creating a relatively light and yet mechanically sound structure.

Next, in the solvent exchange step 26, the hydrogel 42 undergoes a solvent exchange process in which the aqueous solvent in the hydrogel 42 (e.g., the water from the initial raw gel 30) is exchanged with an organic solvent, such as ethanol, by soaking the hydrogel 42 in one or more solvent exchange baths. The solvent exchange baths may be, for example, a mixture of the aqueous solvent (e.g., water) and the organic solvent (e.g., ethanol) ranging anywhere from about 20:80 organic solvent:water (on a volume basis) to 100% organic solvent. The solvent exchange process may include soaking the hydrogel 42 in multiple such solvent exchange baths, with successively larger concentrations of organic solvent, with the final solvent exchange bath being 100% organic solvent (and none of the aqueous solvent). Table 1 below shows five test series of solvent exchange baths that were evaluated.

TABLE 1
Sample Solvent Exchange Baths

| Sample | Bath 1 | Bath 2 | Bath 3 |
|---|---|---|---|
| Mk 6.1 | 100% DI Water | 100% DI Water | 100% Ethanol |
| Mk 6.2 | 20% Ethanol | 40% Ethanol | 100% Ethanol |
| Mk 6.3 | 40% Ethanol | 60% Ethanol | 100% Ethanol |
| Mk 6.4 | 60% Ethanol | 80% Ethanol | 100% Ethanol |
| Mk 6.5 | N/A | N/A | 100% Ethanol |

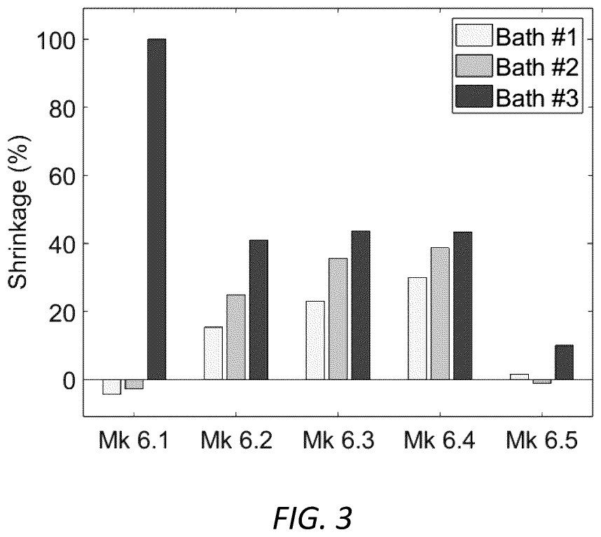

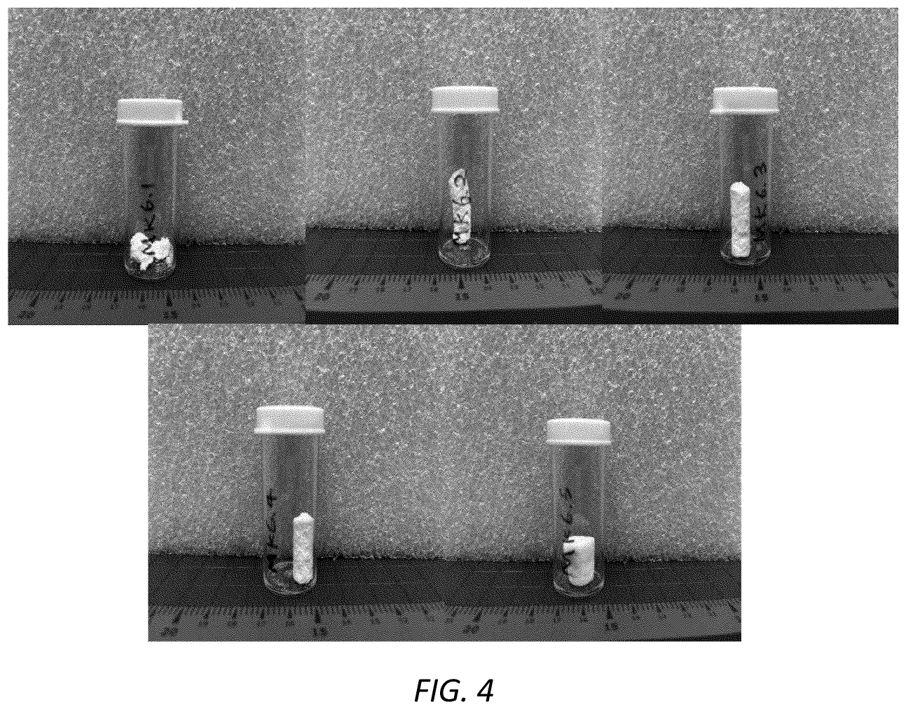

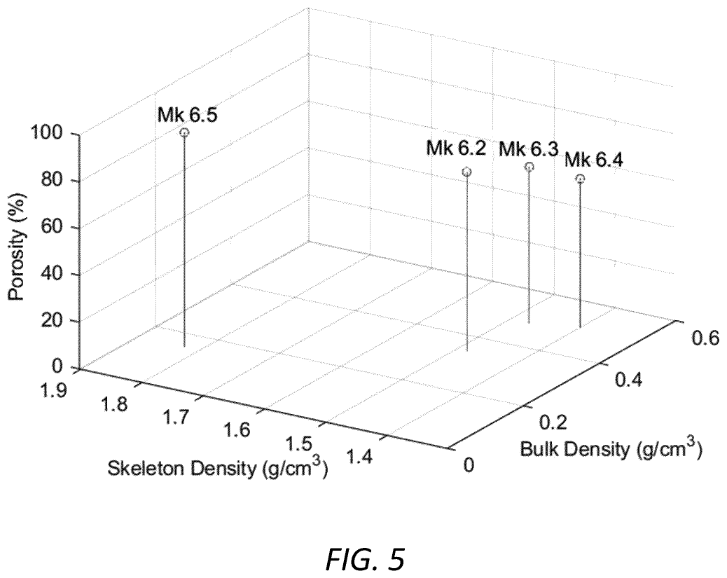

The results of these tests are shown in images of FIG. 4 and graphs of FIGS. 3 and 5. The tests revealed that the samples had porosities generally above about 70%, with a maximum porosity of about 92% and a thermal conductivity of 0.05 W/m-K being obtained from the Mk 6.5 sample. In addition, the Mk 6.5 sample clearly had the highest gel skeleton density and lowest bulk density. Samples Mk 6.2 through 6.4 retained their nanoporous structures during supercritical drying (SCD) while the Mk 6.5 sample through deep freezing protocol (DFP) and SCD showed the least shrinkage during the solvent exchange process (Table 1 and FIG. 3). Sample Mk 6.1 did not survive bath 3 and SCD, which can be seen in the comparison images in FIG. 4. Thus, it was concluded that the tested series of increasing ethanol concentrations in the successive baths had a significant impact on the porosity, thermal conductivity, and density of the resulting compostable polymer aerogel, with the solvent exchange process implementing only a single bath of 100% ethanol (sample Mk 6.5) providing a polymer aerogel with the lowest shrinkage, highest porosity, highest gel skeleton density, and lowest bulk density.

When the solvent exchange step 26 is complete, the hydrogel 42 is saturated with the organic solvent to form what is referred to herein as a saturated gel or “alcogel” 32. ” The organic solvent is then removed from the gel structure of the alcogel 32 during the drying step 28 by any method that will evaporate or otherwise remove the organic solvent without collapsing or otherwise damaging the nanoporous skeletal gel structure. The removal method may include a vacuum-included method. In some embodiments, the solvent removal process 28 may include the aforementioned supercritical drying (SCD) process and/or deep-freezing protocol (DFP), or some other subtraction process(es) capable of removing a large portion (if not all) of the solvents from the hydrogel 42 without collapsing its nanoporous skeletal structure. In some embodiments, the solvent removal process 28 may include two successive processes: a solvent subtraction process and a supercritical drying process. Some subtraction processes that may be used include, for example, deep freezing protocol, supercritical drying, and/or other methods capable of subtracting the solvent without collapsing the gel structure. After the organic solvent has been subtracted, during the supercritical drying process, the alcogel 32 is exposed to conditions above its critical temperature and pressure. In this supercritical state, any remaining solvent trapped in the gel skeletal structure transitions to a gas without passing through the complete liquid phase to form the compostable polymer aerogel 34. This process removes the solvent without collapsing the delicate gel nanoporous skeletal structure, thereby preserving the nanoporous gel network within the compostable polymer aerogel 34. Thereafter, the compostable polymer aerogel 34 optionally may undergo additional treatments, depending on the final properties desired for the aerogel 34. Such additional treatments may include, for example, making surface modifications, such as treatments to render the aerogel 34 hydrophobic or hydrophilic, to tailor its characteristics for specific applications.

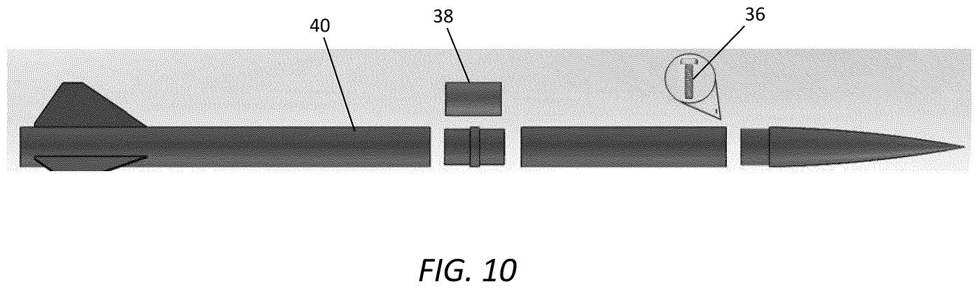

The resulting compostable polymer aerogels 34 are lightweight, solid materials with nanoporous skeletal structures suitable for many aerospace components. Furthermore, the aerogels 34 are biodegradable and compostable because they are made of biodegradable materials. The compostable polymer aerogel 34 can be suitable for use as insulation, such as within payload and avionic bays for high-powered rockets. The compostable polymer aerogels 34 are lightweight materials (typically having a density in the range of about 0.1 to about 0.2 g/cm³ and porosities of greater than 70%) with a low thermal conductivity (typically about or below 0.05 W/m-K). The compostable polymer aerogels 34 may be used to form insulators, such as for avionics bays and waterproof housings for electronics, drawing parallels with conventional polyimide aerogels widely used for insulation today. The compostable polymer aerogels 34 could be used as a replacement for conventional blow-in insulation material used in rockets, which is a cellulose with a thermal conductivity of 0.05 W/m-K and a density of 1.5 g/cm³. Due to their light weight and strength, the compostable polymer aerogels 34 may also be used to form various lightweight structural components for various aerospace applications, such as applications in rockets, spaceships, airplanes, hot air ballons, and/or other aerospace vehicles. For example, as illustrated in FIG. 10, shear pins 36 and/or motor packing 38 for a high-powered rocket 40 (or other aerospace vehicle) may be made from the compostable polymer aerogel 34, for example, using molding, cutting, machining, and/or additive manufacturing (“3D printing”) techniques. Other potential applications include consumer packaging as a replacement for polystyrene foam (e.g., Styrofoam®).

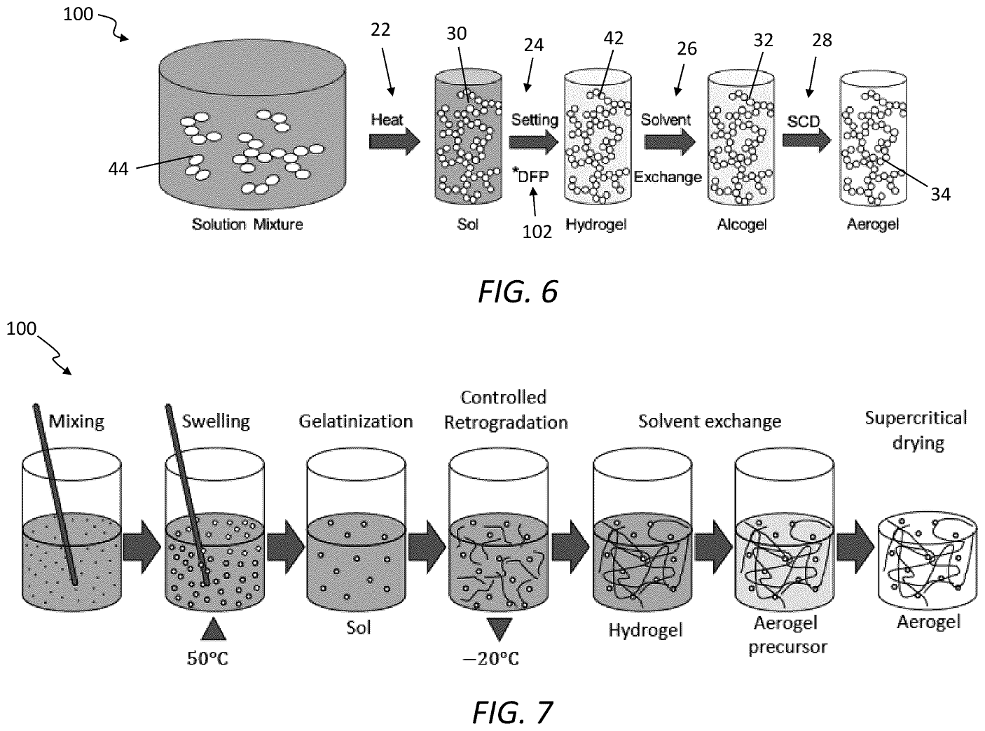

Turning to FIG. 6, another method 100 for producing the polymer aerogels 34 is generally similar to the method 20 but the setting step 24 for setting the raw gel (“sol”) 30 into the hydrogel 42 includes the additional step of incorporating a deep-freezing protocol (DFP) step 102 prior to performing the solvent exchange step 26. The method may include heating the solution mixture at 22 for creating the raw gel 30, setting the gel at 24 using room temperature setting and a deep-freezing protocol to form the hydrogel 42, and solvent exchange at 26 to form the alcogel 32, and before supercritical drying (SCD) to aerogel. It is understood that DFP is not required for setting the raw gel into the hydrogel 42, but it appears to improve stability of the final compostable polymer aerogel structure in at least some embodiments. More specifically, the process 100 implements a full sol-gel process. In one nonlimiting example, the process 100 may start with an initial mixture 44 of biopolymers, plasticizers (if included), and water. In some embodiments, the initial mixture 44 may be the intermediate mixture 18 and/or include other ingredients as disclosed herein; however, other mixtures made of biodegradable components may be used. At 22, the mixture 44 may be heated, allowing the starch to swell and gel, forming the raw gel 30. An acid may be added, causing portions of the glycosidic bonds to break, increasing chain homogeneity. Next at 24, the raw gel 30 may be set in a sealed container at room temperature (e.g., typically about 15-25° C., more typically about 20-22° C.) for 24 hours. During this time, the newly formed hydrogel 42 is believed to undergo a process called retrogradation, where the starch molecules rearrange to the most energetically favorable state. Instead of performing additional retrogradation at room temperature or 4° C., a deep-freezing protocol (DFP) may be implemented before performing the solvent exchange 26, effectively freezing the polymers in place to increase structural robustness. Subsequently, the gels may then undergo solvent exchanges at 26 to form the alcogel 32. Thereafter, the solvent removal process 28 including supercritical drying with liquid CO2 supercritical extraction may be used for the final compostable polymer aerogel. It is believed that increasing the equilibration time and then freezing helps the gel structure be maintained.

FIG. 7 illustrates one nonlimiting example of the process 100 of forming a thermoplastic starch aerogel precursor via a sol-gel process with solvent exchange using the deep-freezing protocol 102. In this process, a mixture of potato starch, water, glycerol, and vinegar is stirred and heated at. At approximately 50° C., the starch granules swell. As the temperature increases above 60° C., the starch granules rupture, releasing amylose and amylopectin into the solution and forming a raw gel. Over time, during gelatinization these molecules interact to create a three-dimensional gel network that traps water, forming a hydrogel. Next, the gel is gradually cooled at room temperature, allowing amylose and amylopectin chains to reassociate into a semi-crystalline structure through retrogradation and subsequent deep-freezing protocol. Water in the hydrogel is then replaced with ethanol via solvent exchange forming a highly porous aerogel precursor (e.g., the alcogel). The ethanol is then subtracted from the aerogel precursor by supercritical drying to produce the compostable polymer aerogel.

In addition to the solvent exchange processes described herein, further efforts to mitigate starch-based aerogel shrinkages and deformations included adding a biopolymer, chitin. Due to its high hydrogen bonding content, chitin has been used before as a gel modifier for increased strength. During investigations leading to the present invention, by adding different wt. % of chitin to the potato starch mixtures described herein, a potato starch/chitin biopolymer blend may help strengthen and lock the starch chains in place during the sol-gel process, also increasing the surface area and thermal stability of the material.

Using the sol-gel process illustrated in FIG. 7, various test samples of the compostable polymer aerogel 34 were formed using both pure potato starch aerogel (PSA) samples and chitin/potato starch blend aerogels (C-PSA). For pure potato starch aerogel (PSA) samples (PSA 1.1-1.5) listed in Table 2 (below), 10 wt. % of potato starch was added into 40 mL of deionized (DI) water while stirring. Once stirred, 1.9 mL of white vinegar and 3.0 mL of glycerol were added to the mixture. The solution mixture was heated to 60° C. and stirred at this temperature until a change in color (white to translucent) and an increase in viscosity was observed. The resulting mixture was poured into cylindrical molds with a diameter of 14.3 mm and covered with parafilm to mitigate solvent loss. Filled molds with sample were set for 24 hours at room temperature (RT) and then followed a range of ethanol/DI water washes or DFP processes (Table 2). Table 2 lists sample solvent exchange bath ethanol/water ratios in percentages. Each bath was applied for 24 hours.

TABLE 2

| Sample | Day #1 | Day #2 | Day #3-5 |
|---|---|---|---|
| PSA 1.1 | DI Water | DI Water | Ethanol 100% |
| PSA 1.2 | Ethanol 20% | Ethanol 40% | Ethanol 100% |
| PSA 1.3 | Ethanol 40% | Ethanol 60% | Ethanol 100% |
| PSA 1.4 | Ethanol 60% | Ethanol 80% | Ethanol 100% |
| PSA 1.5 | DFP (−20° C.) | DFP (−20° C.) | Ethanol 100% |

Hydrogel samples in PSA samples 1.1-1.4 were placed into varying 200-proof ethanol/DI water solution baths for 24 hours as listed in Table 2. The PSA 1.5 sample was kept frozen at −20° C. for 48 hours (DFP) prior to solvent exchange and then placed directly into 200-proof (100%) ethanol with no deionized water. All samples received two more 200-proof ethanol baths. Then, each alcogel sample was dried by supercritical extraction with four soaking and rinse cycles of liquid carbon dioxide (CO2), where supercritical CO2 washes/exchanges at 78 bar and 35° C. were followed by venting. The resulting PSA samples were then tested. Table 3 lists bulk densities, shrinkage, porosity, and surface area of the PSA samples 1.1-1.5 using the different water/ethanol solvent baths of Table 4.

TABLE 3

| PSA | Bulk Density | Shrinkage | Porosity | Surface Area |
|---|---|---|---|---|
| Sample | (g/cm3) | (%) | (%) | (m2/g) |
| PSA 1.1 | N/A | N/A | N/A | 17.6 |
| PSA 1.2 | 0.342 | 41.0 | 77.0 | 25.1 |
| PSA 1.3 | 0.482 | 43.6 | 67.1 | 22.8 |
| PSA 1.4 | 0.502 | 43.4 | 63.9 | 21.0 |
| PSA 1.5 | 0.151 | 10.0 | 91.7 | 54.6 |

For samples with chitin (C-PSA), the total weight percentage of chitin and potato starch is 10 wt. % with 0-7.5 wt. % of potato starch replaced by chitin. Table 4 lists the C-PSA samples 1.0-1.3 made utilizing the PSA 1.5 solvent bath methods described herein, as well as the respective bulk density, shrinkage, porosity, and surface area obtained from each sample. Chitin is added with potato starch to the deionized water prior to adding white vinegar and glycerol. The C-PSA samples were heated for an extra 10 min to ensure a homogeneous mixture was created with the chitin before the next steps. All of the C-PSA samples underwent the PSA 1.5 solvent exchange bath method (24 h at room temperature followed by 48 hours of deep freeze and 3×100% ethanol baths) described previously.

TABLE 4

| | Chitin | Starch | Bulk Density | Shrinkage | Porosity | Surface Area |
|---|---|---|---|---|---|---|
| Sample | (wt. %) | (wt. %) | (g/cm3) | (%) | (%) | (m2/g) |
| C-PSA 1.0 | 0 | 10 | 0.186 | 18.9 | 88.9 | 143.6 |
| C-PSA 1.1 | 2.5 | 7.5 | 0.184 | 19.3 | 87.2 | 151.6 |
| C-PSA 1.2 | 5.0 | 5.0 | 0.164 | 13.1 | 90.2 | 90.1 |
| C-PSA 1.3 | 7.5 | 2.5 | 0.144 | 8.1 | 92.1 | 150.2 |

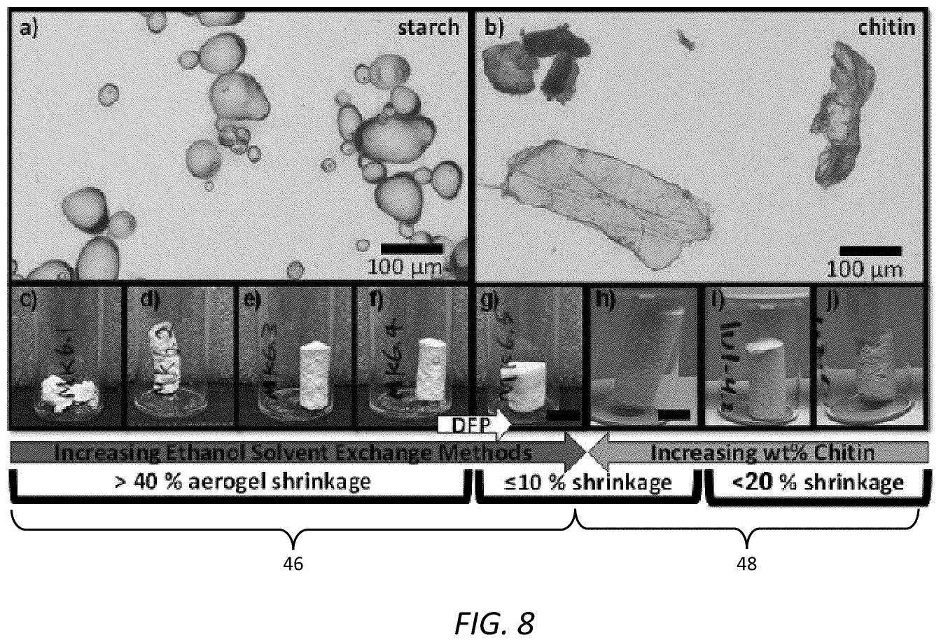

FIG. 8 shows potato starch aerogels in photos (c)-(g) and chitin/potato starch blend aerogels in photos (h)-(j). In photo (a), potato starch is shown under an optical microscope (scale bar: 100 μm). In photo (b), chitin is shown under an optical microscope (scale bar: 100 μm). Photos (c)-(g) show the PSA 1.1-1.5 samples fabricated as listed in Table 4, using alternate sol-gel preparation processes described in Table 3. Photos (h)-(j) shown C-PSA 1.3, 1.2, and 1.1 samples, respectively, as listed in Table 3. The chitin/potato starch blended aerogels in photos (h)-(j) used the same solvent exchange process as PSA 1.5. The scale bar for aerogel samples (c-j) is 10 mm. Increasing ethanol concentration during solvent exchange reduced aerogel shrinkage from over 40% to ≤10%. Further addition of chitin reduced shrinkage to below 20%.

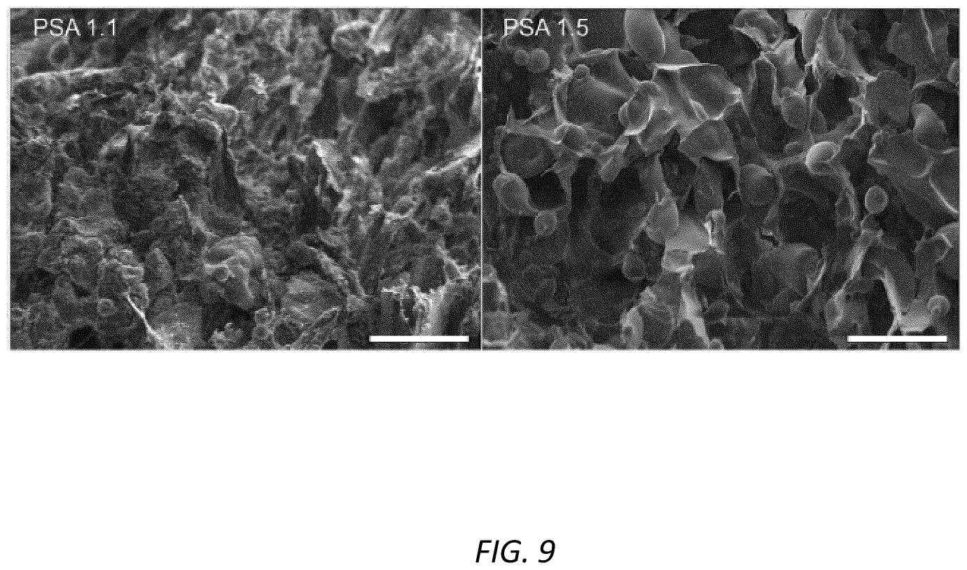

As seen in FIG. 9, the PSA 1.1 sample (left image), which was prepared using two 100% deionized water baths followed by one 100% ethanol bath, exhibited extensive pore collapse, structural deformation, and irregular fractured surfaces. The PSA 1.5 sample (right image), which was prepared using a deep-freezing protocol (DFP) at −20° C. for 48 hours prior to the solvent exchange, followed by solvent exchange of three consecutive 100% ethanol baths, displayed a uniform and well-preserved pore network with interconnected walls and minimal collapse.

An advantage of compostable polymer aerogels described above is their ability to be fabricated using readily available ingredients found in a grocery store, including food starch, glycerin, white vinegar (or any acetic acid source), and ethanol (found in alcoholic beverages like spirits). In addition, food starch can be sourced as a byproduct or waste from the food industry, providing even further environmental benefit through reuse/recycle of this byproduct. The gelation process typically can take place at a temperature of about 60° C. to about 70° C., and therefore does not necessitate the use of a particularly large energy input. Subsequent steps of deep freezing and/or supercritical drying and post-processing can be performed using well-known facilities and processes. In essence, the fabrication of these compostable polymer aerogels is safe and may not require specialized equipment.

In addition, the compostable polymer aerogels are highly versatile and can be molded cut, machined, milled and/or otherwise shaped to form shapes and components of almost any size and/or shape. For example, the compostable polymer aerogels can be easily molded and cut to conform to an intended use. The compostable polymer aerogels are also amenable to 3D printing via liquid deposition modeling (LDM) using the sol-gel (prior to aging), enabling the formation of complex aerogel shapes. The compostable polymer aerogels can also be manufactured in plate form or other standard structural shapes such as beams, etc., facilitating storage.

The biodegradable, compostable polymer aerogels disclosed herein are preferably capable of providing an environmentally friendly alternative derived from starch. The compostable polymer aerogels may, for example, be useful to reduce the environmental impact of traditional plastics incorporated in high-powered rockets. The compostable polymer aerogels may also have potentially superior characteristics to the conventional plastics currently employed in typical aerospace applications.

It is further anticipated that the compostable polymer aerogel disclosed herein may be used to replace single-use, non-degradable materials for shock absorption, thermal insulation, and packaging, by way of nonlimiting examples. The compostable polymer aerogels can be utilized as an alternative to polystyrene foam and other fossil-derived foam materials. In this way, the compostable polymer aerogel may help reduce plastic pollution.

As previously noted above, though the foregoing detailed description describes certain aspects of one or more particular embodiments of the invention, alternatives could be adopted by one skilled in the art. For example, the compostable polymer aerogel could differ in appearance and construction from the embodiments described herein and shown in the drawings, functions of certain components of the compostable polymer aerogel could be performed by components of different construction but capable of a similar (though not necessarily equivalent) function, and various materials could be used in the fabrication of the compostable polymer aerogel. As such, and again as was previously noted, it should be understood that the invention is not necessarily limited to any particular embodiment described herein or illustrated in the drawings.

1. An intermediate mixture for fabricating a compostable polymer aerogel, the intermediate mixture comprising:
at least one biodegradable starch polymer;
a biodegradable plasticizer;
a biodegradable chemical initiator; and
an aqueous solvent.

2. The intermediate mixture of claim 1, wherein the at least one biodegradable starch polymer comprises amylose and amylopectin.

3. The intermediate mixture of claim 2, wherein the at least one biodegradable starch polymer is at least one of a potato starch, a corn starch, and a rice starch.

4. The intermediate mixture of claim 2, wherein the amylose and the amylopectin are present at a ratio of 30:70%, respectively, in the biodegradable starch.

5. The intermediate mixture of claim 1, further comprising chitin.

6. The intermediate mixture of claim 1, wherein the biodegradable plasticizer comprises a vegetable-derived glycerol.

7. The intermediate mixture of claim 1, wherein the biodegradable chemical initiator comprises acetic acid.

8. The intermediate mixture of claim 1, wherein the aqueous solvent comprises water.

9. A process of fabricating a compostable polymer aerogel, the process comprising:
dissolving at least one biodegradable starch polymer, a biodegradable plasticizer, and a biodegradable chemical initiator in an aqueous solvent to form an intermediate mixture;
causing a gelation reaction in the intermediate mixture by heating the intermediate mixture to a gelation temperature for a period of time sufficient to form a raw gel;
aging the raw gel in a sealed environment that prevents escape of the aqueous solvent from a gel structure to form a hydrogel having a nanoporous structure;
saturating the hydrogel with an organic solvent; and
removing the organic solvent from the hydrogel without collapsing the nanoporous structure to form the compostable polymer aerogel.

10. The process of claim 9, further comprising performing a deep freeze protocol on the hydrogel prior to the saturating step.

11. The process of claim 9, further comprising including chitin in the intermediate mixture.

12. The process of claim 9, wherein the step of causing the gelation reaction comprises heating the intermediate mixture to a temperature between about 50° C. and about 95° C. over a period of time sufficient to form the sol-gel.

13. The process of claim 12, wherein step of aging comprises maintaining the sol-gel in the sealed environment for a period of time between about 4 hours and about 24 hours.

14. The process of claim 9, wherein the step of saturating the hydrogel comprises a solvent exchange process of soaking the hydrogel in a solvent exchange bath having 100% concentration of the organic solvent.

15. The process of claim 14, wherein the solvent exchange process further comprises soaking the hydrogel in a first solvent exchange bath having between about 20% and less than 100% concentration of the organic solvent prior to soaking the hydrogel in a second solvent exchange bath having a 100% concentration of the organic solvent.

16. The process of claim 9, wherein the step of removing the organic solvent comprises at least one of deep freezing the saturated hydrogel and supercritical drying the hydrogel.

17. The process of claim 9, wherein the step of removing the organic solvent comprises transitioning any remaining solvent in the hydrogel to a gas without passing through the liquid phase.

18. The process of claim 9, wherein the step of removing the organic solvent from the hydrogel comprises:
subtracting the organic solvent from the hydrogel without collapsing the nanoporous structure; and
removing remaining organic solvent after the subtracting step by exposing the hydrogel to conditions above its critical temperature and critical pressure to form the compostable polymer aerogel.

19. A compostable polymer aerogel fabricated according to the process of claim 9.

20. A compostable polymer aerogel comprising a gel having a nanoporous skeletal structure formed of biodegradable starch polymer, biodegradable plasticizer, and a biodegradable chemical initiator, wherein the gel has a density of about 0.1 to about 0.2 g/cm³ and a thermal conductivity of about 0.05 W/m-K or less.

21. The compostable polymer aerogel of claim 20, wherein the compostable aerogel is configured in the form at least one of an aerospace component, an insulation material, and a structural component.
